(19) United States
(12) Patent Application Publication
(10) Pub. No.: US 2009/0133889 A1
(43) Pub. Date: May 28, 2009

(54) Hand-held power tool having auxiliary handle with clamping band

(75) Inventors: Valentin Keller, Augsburg (DE); Pascal Schilling, Germering (DE); Manfred Ludwig, Landsberg (DE); Thomas Hofbrucker, Mammendorf (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/291,525

(22) Filed: Nov. 10, 2008

(30) Foreign Application Priority Data
Nov. 28, 2007 (DE) 10 2007 047 881.1

(51) Int. Cl. B25D 17/00

(52) U.S. Cl. 173/104

(57) ABSTRACT

A hand-held power tool includes a locking flange (2), and an auxiliary handle (1) securable to the locking flange (2) and having a head (4), a loop-shaped clamping band (5) located in the head (4), at least one, radially inwardly projecting cam (11a, 11b) provided on the clamping band (5) and formlockingly engageable in an associated recess (12a, 12b) formed in the locking flange (2), and a member for manually tensioning the clamping band (5).

### BACKGROUND OF THE INVENTION

1. Field of the Invention

The present invention relates to a hand-held power tool with an auxiliary handle having a clamping band and, in particular, to a hammer drill.

2. Description of the Prior Art

Usually, an auxiliary handle is secured on a cylindrical locking flange of a power tool with a clamp, a clamping yoke, or a clamping band. Often, on the auxiliary handle, there is also provided a depth stop in form of a rigid, displaceably securable bar.

European Publication EP 0 132 593 discloses an auxiliary handle securable on a locking flange of a hand-held power tool with a loop-shaped clamping band. The clamping band is tensioned by a locking screw upon rotation of a hand grip. The auxiliary handle has a head that is formlockingly adapted to the locking flange and, with the auxiliary handle secured in a predetermined manner, is positioned relative to the rotational axis of the power tool. Additionally, a depth stop is formlockingly and displaceably secured in the auxiliary handle. The clamping band loop is displaced over V-shaped guide surfaces of the head. This can lead to loosening of the locking screw which is formlockingly received in receiving openings provided in the ends of the clamping band which are guided along the head upon a wider opening of the clamping band loop.

German Publication DE 10 2005 057 269 discloses an auxiliary handle with a clamping yoke having a partially circumferential guide web that axially formlockingly engages in a circumferential guide groove provided on the associated cylindrical locking flange of a hand-held power tool. The end surface of the clamping yoke is provided with recesses in which circumferentially distributed noses tangentially formlockingly engage. As a result, the locked auxiliary handle is completely formlockingly secured, in addition to being frictionally secured.

The object of the present invention is to provide a hand-held power tool having an auxiliary handle that can be completely formlockingly secured on the hand-held power tool in a manner suitable for use in constructional industry.

### SUMMARY OF THE INVENTION

This and other objects of the present invention, which will become apparent hereinafter are achieved by providing a hand-held power tool having an auxiliary handle securable on the locking flange of the power tool and having a head positioned relative to an operational axis, a loop-shaped clamping band located in the head and guided therein, at least one, radially inwardly projecting cam provided on the clamping band and formlockingly engageable in an associated recess formed in the locking flange, and means for manually tensioning the clamping band. The radially inwardly projecting cam provides for a formlocking attachment of the auxiliary handle to the locking flange, in addition to frictional locking.

Advantageously, the auxiliary handle has a plurality of radially inwardly projecting cams offset relative to each other along a clamping band loop. With a plurality of cams, the formlocking connection can absorb large forces.

Advantageously, there are provides at least two different types of cams. The different types of cams can include elongate transverse cams extending transverse to the loop, elongate cams extending along the loop, and spherical cap-shaped cams. These cams permit to achieve (with respect to the locking flange) both axial and tangential formlocking action, without increasing bending stiffness along the loop.

Advantageously, the clamping band is formed of metal, preferably, of spring steel, which permits to achieve high locking forces, together with a high elasticity. In addition, the cams, which are coined from metal, are characterized by a high wear resistance and, therefore, have an extended service life.

Advantageously, the manually tensioning means includes a rotatable hand grip and a locking screw for tensioning the band in response to a respective rotation of the hand grip. Thereby, the locking is easily carried out by rotating the hand grip.

Advantageously, the clamping band has two receiving openings provided in its opposite ends respectively, for formlockingly receiving a head of a locking screw. As a result, the clamping band is locked with a screw.

Advantageously, the clamping band has two, radially outwardly projecting, guide noses provided respectively on its two opposite ends. Thereby, upon releasing the clamping band, the open width of the two ends of the clamping band is determined by the guide surfaces of the locking flange. Thereby, falling of the locking screw off the head upon opening of the receiving openings can be prevented.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side elevational view of a hand-held power tool according to the present invention with an auxiliary handle;

FIG. 2 a cross-sectional view along line II-II in FIG. 1;

FIG. 3 a side view of the locking flange; and

FIG. 4 a perspective view of a section of a clamping band loop.

### DETAILED DESCRIPTION OF THE PREFERRED EMBODIMENT

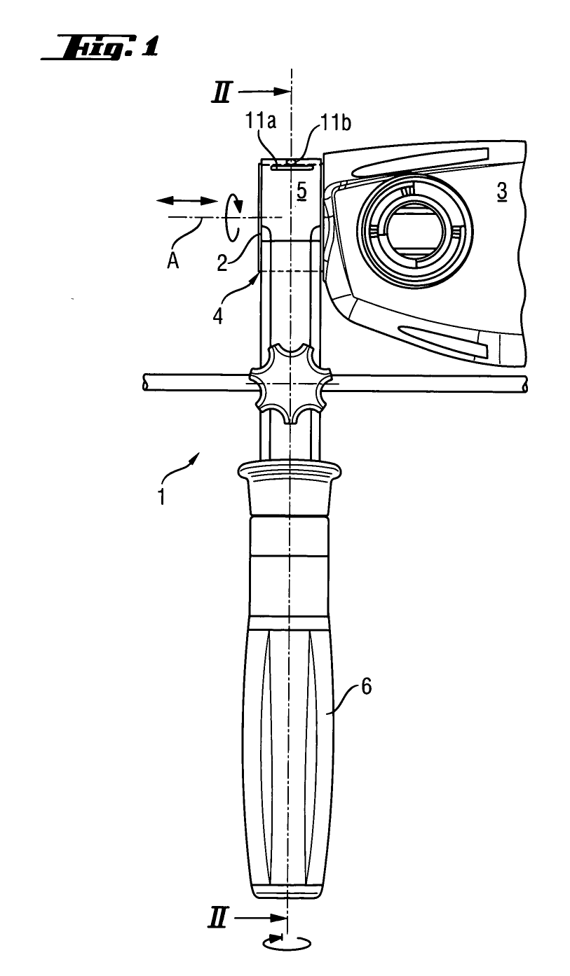

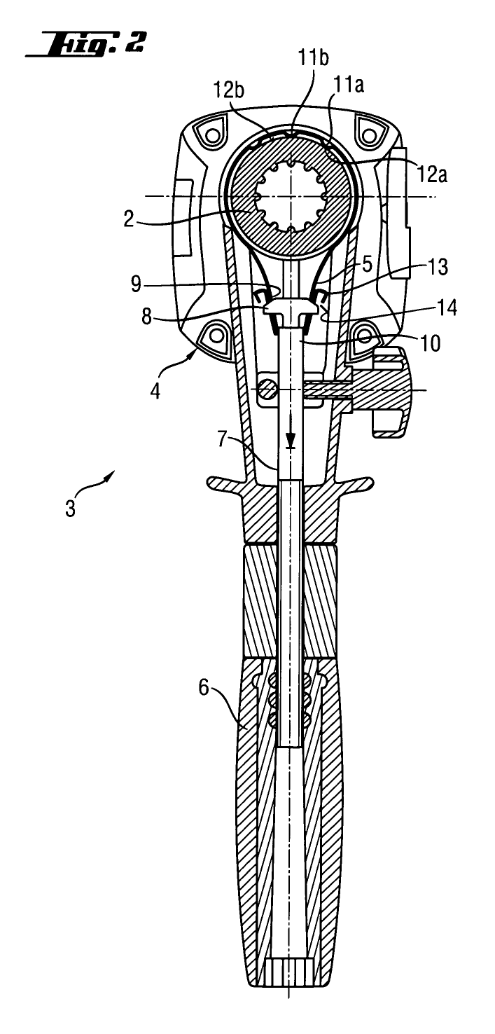

A hand-held power tool 3, which is formed as a hammer drill and is only partially shown in FIGS. 1 and 2, has a locking flange 2 to which an auxiliary handle 1 that is positioned relative to the operational axis A of the power tool 3, is secured. The auxiliary handle 1 has a head 4 formlockingly adapted to the locking flange 2.

In the head 4, a loop-shaped clamping band 5, which is formed of spring steel, is displaceably arranged. The clamping band 5 is tensioned by a manual rotation of a hand grip 6, with a head 8 of a locking screw 7 and which engages in receiving openings 9 in both ends 10 of the clamping band 5. On the clamping band 5, on a loop section opposite the handle 6, there are provided a plurality of longitudinally offset, radially inwardly projecting cams 11a, 11b.

The cams 11a, 11b formlockingly engage in associated recesses 12a, 12b in the locking flange 2 of the power tool 3. The locking band 5 has, on both of its ends 10, projecting radially outwardly, guide noses 13, respectively. The guide noses 13 displace, upon locking/unlocking, on respective, substantially parallel to each other guide surfaces 14 of the head 4.

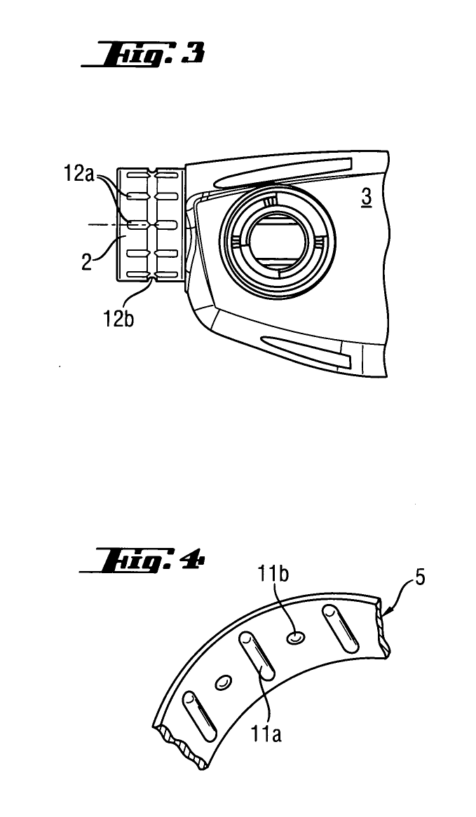

As shown in FIGS. 3 and 4, the cams 11a of the clamping band 5, which are necessary for radially securing the clamping band 5, a formed as elongate transverse cam extending transverse to the clamping band loop. The transverse cams 11a engage in recesses 12a, which are formed as elongate grooves in the locking flange 2. The cams 11b which are necessary for axially securing the clamping band are formed as circular spherical cap-shaped cams engageable in a recess 12b in form of a circumferential groove provided in the locking flange 2.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool, comprising a locking flange (2); and an auxiliary handle (1) securable to the locking flange (2) and having a head (4) positioned relative to an operational axis (A), a loop-shaped clamping band (5) located in the head (4) and guided therein, at least one, radially inwardly projecting cam (11a, 11b) provided on the clamping band (5) and formlockingly engageable in an associated recess (12a, 12b) formed in the locking flange (2), and means for manually tensioning the clamping band (5).

2. A hand-held power tool according to claim 1, wherein the auxiliary handle (1) has a plurality of radially inwardly projecting cams (11a, 11b) offset relative to each other along a clamping band loop.

3. A hand-held power tool according to claim 2, wherein the plurality of radially inwardly projecting cams (11a, 11b) includes two types of cams.

4. A hand-held power tool according to claim 1, wherein the clamping band (5) is formed of metal.

5. A hand-held power according to claim 1, wherein the manually tensioning means comprises a rotatable hand grip (6) and a locking screw (7) for tensioning the band in response to a respective rotation of the hand grip (6).

6. A hand-held power tool according to claim 1, wherein the clamping band (5) has two receiving openings (9) provided in opposite ends (10) thereof, respectively, for formlockingly receiving a head (8) of a locking screw (7).

7. A hand-held power tool according to claim 1, wherein the clamping band (5) has two, projecting radially outwardly, guide noses (13) provided, respectively, on two opposite ends (10) thereof.

8. A hand-held power tool according to claim 7, wherein the head (4) has two guide surfaces (14) along which the two ends (10) of the clamping band (5) are displaceable.
